(19) United States
(12) Patent Application Publication
(10) Pub. No.: US 2012/0110594 A1
(43) Pub. Date: May 3, 2012

(54) LOAD BALANCING WHEN ASSIGNING OPERATIONS IN A PROCESSOR

(75) Inventors: Emil Talpes, Sunnyvale, CA (US); Ganesh Venkataramanan, Sunnyvale, CA (US); Sean Lie, Santa Clara, CA (US)

(73) Assignee: ADVANCED MICRO DEVICES, INC., Sunnyvale, CA (US)

(21) Appl. No.: 12/914,483

(22) Filed: Oct. 28, 2010

(51) Int. Cl. G06F 9/46

(52) U.S. Cl. 718/105

(57) ABSTRACT

A method and apparatus for assigning operations in a processor are provided. An incoming instruction is received. The incoming instruction is capable of being processed: only by a first processing unit (PU), only by a second PU or by either first and second PUs. The processing of first and second PUs is load balanced by assigning the received instructions capable of being processed by either the first and the second PUs based on a metric representing differential loads placed on the first and the second PUs.

### FIELD OF INVENTION

This application is related to processor technology.

### BACKGROUND

As processor systems evolve, emphasis is placed on performance speed. In order to achieve fast performance, technological advances are accomplished in terms of the scale of on-chip processors as well as more efficient completion of computing tasks. Therefore, it is increasingly important to discover ways to make processors run more efficiently. One of these ways is through efficient assignment of tasks during the pipelining of operations. One area that affects efficiency is the assignment of operations that are going from a decoder and entering a scheduling unit.

### SUMMARY OF EMBODIMENTS OF THE INVENTION

Embodiments provide a method and apparatus for assigning operations in a processor. In the exemplary method and apparatus an incoming instruction is received. The incoming instruction is capable of being processed: only by a first processing unit (PU), only by a second PU or by either the first and the second PUs. The processing of the first and the second PUs is load balanced by assigning the received instructions capable of being processed by either the first and the second PUs based on a metric representing differential loads placed on the first and the second PUs.

In one embodiment the metric is compounded over at least one of three or four clock cycles. Four incoming instructions may be received in parallel during a clock cycle. In another embodiment, the metric is compounded over the four incoming instructions.

In one embodiment, instructions capable of being processed by either the first and the second PUs are assigned to first PU on the condition that the metric indicates more second PU assignments than first PU assignments. In another embodiment, instructions capable of being processed by either the first and the second PUs are assigned to the second PU on the condition that the metric indicates more first PU assignments than second PU assignments.

Further, in another embodiment, an indicator is provided, where the indicator indicates that instructions capable of being processed by either the first and the second PUs is assigned to the second PU when the indicator is triggered and to the first PU when the indicator is not triggered.

### BRIEF DESCRIPTION OF THE DRAWINGS

A more detailed understanding may be had from the following description, given by way of example in conjunction with the accompanying drawings wherein:

FIG. 1 shows a description of a processor and its components;

FIG. 2 shows a block diagram of a method for load balancing; and

FIG. 3 shows a schematic of circuit logic implementation of load balancing.

### DETAILED DESCRIPTION

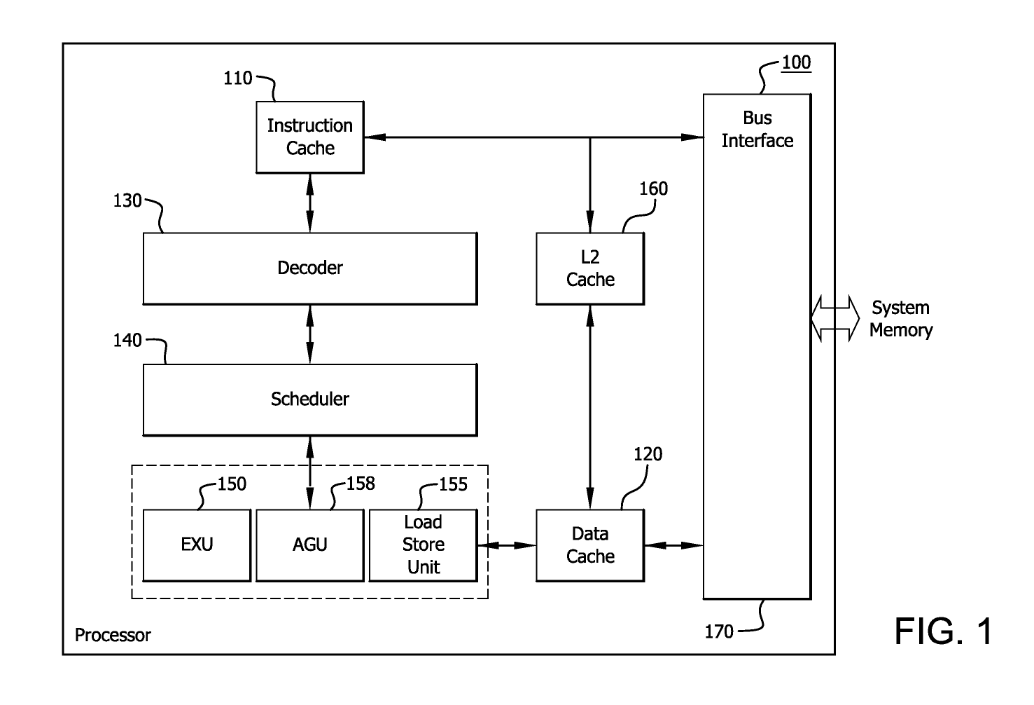

FIG. 1 shows an embodiment of a processor. Processor 100 is configured to execute instructions stored in a system memory. Many of these instructions may operate on data also stored in the system memory. It is noted that the system memory may be physically distributed throughout a computer system and may be accessed by one or more processors such as processor 100. In one embodiment, processor 100 is an example of a processor which, as illustrated, is a central processing unit (CPU) which implements an x86 architecture. However, other embodiments are contemplated which include other types of processors, such as an Advanced RISC (Reduced Instruction Set Computer) Machine (ARM), a Digital Signal Processor (DSP), or a microcontroller. Further, processor 100 may be a multi-core processor or a single-core processor.

In the illustrated embodiment, processor 100 includes an instruction cache 110 and a data cache 120. Although various scenarios may be used for the caches included in processor 100, the instruction cache 110 and data cache are level one (L1) caches.

Processor 100 further includes an on-chip level 2 (L2) cache 160 which is coupled between instruction cache 110, data cache 120 and system memory. It is noted that alternative embodiments are contemplated in which the L2 cache 160 resides off-chip.

Processor 100 also includes an instruction decoder 130, which is coupled to instruction cache 110 to dispatch operations to a scheduler 140. The scheduler 140 is coupled to receive operations and to issue operations to execution unit 150. Load and store unit 155 may be configured to perform accesses to data cache 120. Results generated by execution unit 150 may be used as operand values for subsequently issued instructions and/or stored to a register file (not shown in FIG. 1).

Processor 100 includes an Address Generation Unit (AGU) 158. AGU 158 is capable of performing address generation operations, and may be capable of performing simple execution-type operations as well. For instance, an AGU may be capable of performing simple increment and decrement operations. In a sense, the AGU 158 is capable of performing pure execution operations. A scheduler 140 is coupled to receive operations and to issue operations to execution unit 150.

Instruction cache 110 may store instructions before execution. Further, in one embodiment, instruction cache 110 may be implemented in static random access memory (SRAM), although other embodiments are contemplated which may include other types of memory.

Instruction decoder 130 may be configured to decode instructions into operations, which may be either directly decoded or indirectly decoded using operations stored within an on-chip read-only memory (ROM). Instruction decoder 130 may decode certain instructions into operations executable within the processor 100 execution units. Simple instructions or micro operations (uops) may correspond to a single operation. In some embodiments, complex instructions (Cops) may correspond to multiple operations.

Scheduler 140 may include one or more scheduler units (e.g., an integer scheduler unit and a floating point scheduler unit). It is noted that as used herein, a scheduler is a device that detects when operations are ready for execution and issues ready operations to one or more units for execution. Each scheduler 140 may be capable of holding operation information (e.g., bit encoded execution bits as well as operand values, operand tags, and/or immediate data) for several pending operations awaiting issue to an execution unit 150, or an address generation unit 158. In some embodiments, each scheduler may be associated with one of an execution unit or an address generation unit, whereas in other embodiments, a single scheduler may issue operations to more than one of an execution unit or an address generation unit. Also in some embodiments multiple execution units and address generation units are serviced by multiple schedulers.

In other embodiments, processor 100 may be a superscalar processor, in which case execution unit 150 may include multiple execution units (e.g., a plurality of integer execution units (not shown)) configured to perform integer arithmetic operations of addition and subtraction, as well as shifts, rotates, logical operations, and branch operations. In addition, one or more floating-point units (not shown) may also be included to accommodate floating-point operations. An address generation unit (AGU) may be configured to perform address generation for load and store memory operations to be performed by load/store unit 155.

Load/store unit 155 may be configured to provide an interface between execution unit 150 and data cache 120. In one embodiment, load/store unit 155 may be configured with a load/store buffer (not shown) with several storage locations for data and address information for pending loads or stores.

Data cache 120 is a cache memory provided to store data being transferred between load/store unit 155 and the system memory. Similar to instruction cache 110 described above, data cache 120 may be implemented in a variety of configurations, including a set associative configuration.

L2 cache 160 is also a cache memory and it may be configured to store instructions and/or data. In the illustrated embodiment, L2 cache 160 is an on-chip cache and may be configured as either fully associative or set associative or a combination of both. In one embodiment, L2 cache 160 may store a plurality of cache lines where the number of bytes within a given cache line of L2 cache 160 is implementation specific. It is noted that L2 cache 160 may include control circuitry (not shown in FIG. 1) for scheduling requests, controlling cache line fills and replacements, and coherency, for example.

Bus interface unit 170 may be configured to transfer instructions and data between system memory and L2 cache 160 and between system memory and instruction cache 110 and data cache 120. In one embodiment, bus interface unit 170 may include buffers (not shown) for buffering write transactions during write cycle streamlining. In one particular embodiment of processor 100 employing the x86 processor architecture, instruction cache 110 and data cache 120 may be physically addressed. The method and apparatus disclosed herein may be performed in any processor including but not limited to large-scale processors used in computer and game console processors.

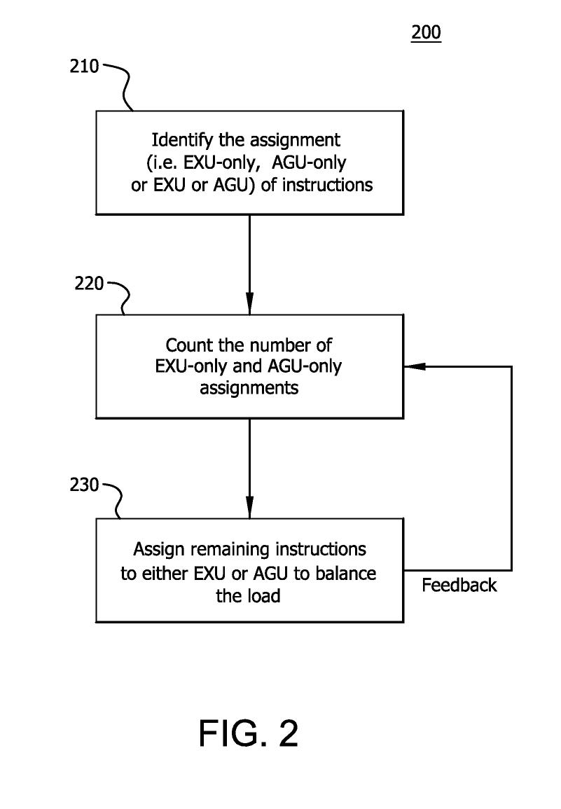

FIG. 2 shows a flow chart of the steps employed in an embodiment of the method for load balancing disclosed herein. Instructions are assigned to a particular hardware unit. For the purposes of describing the method 200, the instructions may be assigned to an Execution Unit (EXU) only, an Address Generation Unit (AGU) only, or either an EXU or an AGU. In some embodiments, the AGU is capable of performing certain execution-type operations that are normally performed by the EXU. For instance, in these embodiments, an AGU is capable of performing an address calculation so a processor may find a memory location. These calculations may include integer operations, increments, or decrements. Therefore, some operations may be assigned to either of an EXU or an AGU. On the converse, other operations may only be performed by an EXU, or only by an AGU.

In step 210, the assignment of each instruction is identified (EXU only, AGU only or either EXU or AGU). Then, in step 220, the number of instructions that are EXU only and AGU only assignments are each counted. These instructions are counted according to their destination as either going to an EXU or an AGU. In this particular embodiment, certain instructions may be assigned to either an EXU or an AGU, but other types of hardware, and, therefore, assignments are within the scope of the invention.

Moving on to step 230, the destination of instructions that may be assigned to either an EXU or an AGU is determined based on instruction count and a criterion to balance the load. In one embodiment, the criterion includes evening out the number of instructions destined to the AGU with the number of instructions destined to the EXU. Therefore, according to this embodiment, instructions that are capable of being assigned to either of the AGU or the EXU are accordingly assigned in a manner that balances instructions entering the two units. For example, if AGU currently has a higher instruction count than EXU, instructions capable of going to either the AGU or the EXU will be sent to the EXU. Information regarding such balancing may be fed back via a feedback loop.

In another embodiment and to provide an additional example, where a recent history of dispatched instructions suggest a higher number of AGU assignments than EXU assignments, then instructions capable of being assigned to either unit will be assigned to the EXU because the EXU is the less busy unit. A feedback loop, shown in FIG. 2, ensures that the assigned instruction destination may be accounted for when counting the number of EXU and AGU assignments in step 220.

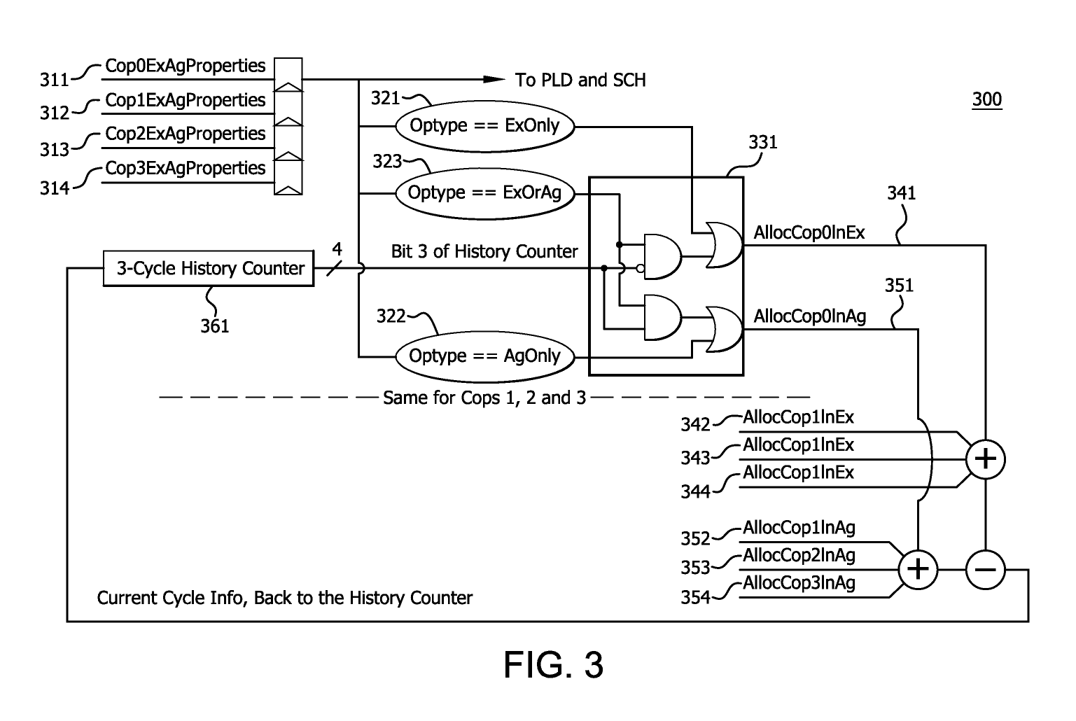

Referring now to FIG. 3 and according to another embodiment, two types of instructions are dispatched by a decoder and forwarded to a scheduler; an execution (EX) instruction and an address generation (AG) instruction. The example logic shown in FIG. 3 classifies the instructions into three categories: 1) instructions which may be dispatched to an EXU only, 2) instructions which may be dispatched to an AGU only, and 3) instructions which may be dispatched to either an EXU or an AGU.

In FIG. 3, over a single clock cycle four instructions (which again for purposes of describing the invention are complex operations) are dispatched by the decoder to the scheduler. The lines Cop0ExAgProperties 311, Cop1ExAgProperties 312, Cop2ExAgProperties 313, and Cop3ExAgProperties 314 carry information regarding the assignment of these instructions. Line Cop1ExAgProperties 311 is fed into three logical units to be classified. The first logical unit 321 determines whether the instruction is EXU only (i.e. bound to the EXU) and flags accordingly (in this instance, by generating an output of “1” to indicate an EXU only operation and an output of “0” to indicate otherwise). Similarly, the second logical unit 322 determines whether the instruction is AGU only (i.e. bound to the AGU) and flags accordingly (in this instance, by generating an output of “1” to indicate an AGU only operation and an output of “0” to indicate otherwise). The third logical unit 323 will be discussed shortly herein.

To reflect the type of operation, when an instruction is EXU only, the logical circuit 331, shown in FIG. 3, will flag line AllocCop0InEx 341 with an output of “1”, and when an instruction is AGU only the logical circuit will flag line AllocCop0InAg 351 with an output of “1”. In a similar manner, lines AllocCop1InEx 342 and AllocCop1InAg 352 reflect whether the second instruction in a clock cycle, whose properties are fed through line Cop1ExAgProperties 312, is EXU only or AGU only, respectively. Furthermore, lines AllocCop2InEx 343 and AllocCop2InAg 353 reflect whether the third instruction in a clock cycle, whose properties are fed through line Cop2ExAgProperties 313, is EXU only or AGU only, respectively, and lines AllocCop3InEx 344 and AllocCop3InAg 354 reflect whether the fourth instruction in a clock cycle, whose properties are fed through line Cop3ExAgProperties 314, is EXU only or AGU only, respectively.

Lines AllocCop0InEx 341, AllocCop1InEx 342, AllocCop2InEx 343, and AllocCop3InEx 344 are then added to determine the total number of EXU-bound assignments. Lines AllocCop0InAg 351, AllocCop1InAg 352, AllocCop2InAg 353, and AllocCop3InAg 354 are also added to determine the total number of AGU-bound assignments. A differential between the number of EXU-bound assignments and the number of AGU-bound assignments is then calculated. This differential is fed to a 3-cycle History Counter 161 that retains a differential count for three cycles. However, other embodiments may utilize a History Counter 161 that compounds differentials for a different number of cycles.

An output of the 3-Cycle History Counter 161 is fed to the logical circuit. In this embodiment, the output is the 3-Cycle History Counter's 161 sign bit. Therefore, an output of “1” indicates an imbalance in favor of EXU-bound instructions and causes incoming non-fixed instructions (i.e., in this embodiment, instructions flagged by the third logical unit 323) to be directed to the AGU, which results in line AllocCop0InAg 351 being flagged (i.e., “1” output). Conversely, an output of “0” indicates that there are more AGU-bound instructions than EXU-bound instructions and therefore incoming non-fixed instructions are assigned to the EXU, which results in line AllocCop0InEx 341 being flagged (i.e., “1” output).

In one embodiment, a map unit, also referred to as a renamer, is responsible for assigning instructions to an execution unit scheduler or to an address generation unit scheduler. The renamer maintains mapping of dispatched instructions received from a decoder. The mapping may entail a correspondence of architectural register numbers to physical register numbers. In this embodiment, the map unit uses the disclosed method to balance instructions.

Although features and elements are described above in particular combinations, each feature or element may be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of processors, one or more processors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions (such instructions capable of being stored on a computer readable media). The results of such processing may be maskworks that are then used in a semiconductor manufacturing process to manufacture a processor which implements aspects of the present invention.

What is claimed is:

1. A method for assigning operations in a processor comprising:
receiving an incoming instruction, the incoming instruction being capable of being processed: only by a first processing unit (PU), only by a second PU or by either said first and said second PUs; and
load balancing the processing of said first and second PUs by assigning received instructions capable of being processed by either said first and said second PUs based on a metric representing differential loads placed on said first and said second PUs.

2. The method of claim 1 wherein the metric is compounded over at least one of three or four clock cycles.

3. The method of claim 1 further comprising:
receiving four incoming instructions in parallel during a clock cycle.

4. The method of claim 3 further comprising:
compounding the metric over the four incoming instructions.

5. The method of claim 1 further comprising:
assigning said instructions capable of being processed by either said first and said second PUs to said first PU on the condition that the metric indicates more said second PU assignments than said first PU assignments; and assigning said instructions capable of being processed by either said first and said second PUs to said second PU on the condition that the metric indicates more said first PU assignments than said second PU assignments.

6. The method of claim 1 further comprising:
providing an indicator wherein said indicator indicates that said instructions capable of being processed by either said first and said second PUs is assigned to said second PU when the indicator is triggered and to said first PU when the indicator is not triggered.

7. A processor comprising:
a scheduler;
a decoder;
a first processing unit (PU);
a second PU; and
a renamer configured to receive an incoming instruction, the incoming instruction being capable of being processed: only by a first processing unit (PU), only by a second PU or by either said first and said second PUs; the renamer further configured to load balance the processing of said first and second PUs by assigning received instructions capable of being processed by either said first and said second PUs based on a metric representing differential loads placed on said first and said second PUs.

8. The processor of claim 7, wherein the metric is compounded over at least one of three or four clock cycles.

9. The processor of claim 7 further comprising circuitry configured to receive four incoming instructions in parallel during a clock cycle.

10. The processor of claim 9 further comprising circuitry configured to compound the metric over the four incoming instructions.

11. The processor of claim 7 further comprising circuitry configured to assign said instructions capable of being processed by either said first and said second PUs to said first PU on the condition that the metric indicates more said second PU assignments than said first PU assignments; and assigning said instructions capable of being processed by either said first and said second PUs to said second PU on the condition that the metric indicates more said first PU assignments than said second PU assignments.

12. The processor of claim 7 further comprising circuitry configured to indicate that said instructions capable of being processed by either said first and said second PUs is assigned to said second PU when the indicator is triggered and to said first PU when the indicator is not triggered.

13. A computer system comprising:
a system memory; and
a processor coupled to the system memory wherein the processor comprises: a scheduler; a decoder; a first processing unit (PU); a second PU; and a renamer configured to receive an incoming instruction, the incoming instruction being capable of being processed: only by a first processing unit (PU), only by a second PU or by either said first and said second PUs; the renamer further configured to load balance the processing of said first and second PUs by assigning received instructions capable of being processed by either said first and said second PUs based on a metric representing differential loads placed on said first and said second PUs.

14. The computer system of claim 13 wherein the metric is compounded over three or four clock cycles.

15. The computer system of claim 13 further comprising circuitry configured to assign four incoming instructions in parallel during a clock cycle.

16. The computer system of claim 15 further comprising circuitry configured to compound the metric over the four incoming instructions.

17. The computer system of claim 13 further comprising circuitry configured to assign said instructions capable of being processed by either said first and said second PUs to said first PU on the condition that the metric indicates more said second PU assignments than said first PU assignments; and assigning said instructions capable of being processed by either said first and said second PUs to said second PU on the condition that the metric indicates more said first PU assignments than said second PU assignments.

18. The computer system of claim 13 further comprising circuitry to indicate that said instructions capable of being processed by either said first and said second PUs is assigned to said second PU when the indicator is triggered and to said first PU when the indicator is not triggered.

19. A computer-readable storage medium storing a set of instructions for execution by a general purpose computer to assign operations in a processor, the set of instructions comprising:
a receiving code segment for receiving an incoming instruction, the incoming instruction being capable of being processed: only by a first processing unit (PU), only by a second PU or by either said first and said second PUs; and
a load balancing code segment for load balancing the processing of said first and second PUs by assigning received instructions capable of being processed by either said first and said second PUs based on a metric representing differential loads placed on said first and said second PUs.

20. The computer readable storage medium of claim 19, wherein the set of instructions are hardware description language (HDL) instructions used for the manufacture of a device.
